(19) United States
(12) Patent Application Publication
(10) Pub. No.: US 2019/0092309 A1
(43) Pub. Date: Mar. 28, 2019

(54) VEHICLE MONITORING BRAKE CONDITION AND METHOD FOR CONTROLLING THE SAME

(71) Applicants: Hyundai Motor Company, Seoul (KR); Kia Motors Corporation, Seoul (KR)

(72) Inventors: Daeyun An, Anyang (KR); Seunghyun Woo, Seoul (KR); Seok-Young Youn, Seoul (KR); Gi Beom Hong, Bucheon (KR)

(21) Appl. No.: 15/826,262

(22) Filed: Nov. 29, 2017

(30) Foreign Application Priority Data
Sep. 27, 2017 (KR) 10-2017-0124780

(51) Int. Cl. B60T 17/22; F16D 66/02; G07C 5/00; B60R 16/023; G07C 5/08

(52) U.S. Cl. CPC B60T 17/221; F16D 66/021; F16D 2066/006; B60R 16/0234; G07C 5/0825; G07C 5/006

(57) ABSTRACT

A vehicle displays a result of monitoring whether a loaded condition is abnormal based on a lining wear condition of a brake. The vehicle includes a lining wear condition detector to detect the lining wear condition of the brake, a load detector to detect a loaded condition, a controller to monitor whether the detected loaded condition is abnormal based on the lining wear condition, and a display to display a monitoring result.

### CROSS-REFERENCE TO RELATED APPLICATION

This application claims under 35 U.S.C. § 119(a) the benefit of Korean Patent Application No. 10-2017-0124780 filed on Sep. 27, 2017, the entire contents of which are incorporated herein by reference.

### BACKGROUND

### 1. Technical Field

The present disclosure relates to a vehicle equipped with a display and a method for controlling the vehicle, more particularly, to a vehicle and a control method capable of monitoring whether a loaded condition is abnormal based on a lining wear condition of a brake and displaying a monitoring result.

### 2. Discussion of Related Art

Vehicles typically are equipped with various convenience features and functions apart from the basic driving function. In particular, a vehicle may include combinations of different types of modules to provide these various convenience features and/or functions.

A driver typically is provided with different types of information about the vehicle, such as the condition of a plurality of parts of the vehicle for maintenance and management of the vehicle. In this regard, the vehicle helps the driver know the condition of the parts of the vehicle by visually and/or audibly outputting information about the condition of the parts.

For example, if the vehicle determines that a part has worn out to a point where normal driving of the vehicle would not be possible, the vehicle may notify the driver of this condition, enabling the driver to replace the part. The vehicle may further make a visual notification by displaying an amount of stored fuel and other information via a cluster display.

### SUMMARY

Embodiments of the present disclosure provide a vehicle and method for controlling the same, which displays a result of monitoring whether a loaded condition is abnormal based on a lining wear condition.

In accordance with one aspect of the present disclosure, a vehicle includes a lining wear condition detector to detect a lining wear condition of a brake, a load detector to detect a loaded condition, a controller to monitor whether the detected loaded condition is abnormal based on the lining wear condition, and a display to display a monitoring result.

The controller is configured to, if the detected lining wear condition is determined as being abnormal by comparison between the lining wear condition and a reference lining wear condition, compare the loaded condition detected after the determination with a reference loaded condition corresponding to the abnormal lining wear condition and control the display to display that the loaded condition is abnormal.

The controller is configured to determine the reference loaded condition by comparing the loaded condition detected under the abnormal lining wear condition and the abnormal lining wear condition.

The controller is configured to determine the reference loaded condition by comparing a lining wear rate pattern at a position of a lining under the lining wear condition and an axial load pattern at a position to which pressure is applied by a load under the loaded condition.

The controller is configured to determine the reference loaded condition by comparing feature points between the lining wear rate pattern and the axial load pattern.

The controller is configured to control the display to display that the lining wear condition is abnormal due to the abnormal loaded condition.

The vehicle may further include a tire wear condition detector to detect a tire wear condition of the vehicle.

The controller is configured to, if the lining wear condition is determined as being abnormal, compare the tire wear condition detected after the determination with a reference tire wear condition corresponding to the abnormal lining wear condition and control the display to display that the tire wear condition is abnormal.

The controller is configured to determine the reference tire wear condition by comparing the tire wear condition detected under the abnormal lining wear condition and the abnormal lining wear condition.

The controller is configured to control the display to display the detected tire wear condition.

The controller is configured to control the display to display a remaining available time corresponding to the tire wear condition.

In accordance with another aspect of the present disclosure, a method for controlling a vehicle includes detecting a lining wear condition of a brake, detecting a loaded condition, monitoring whether the detected loaded condition is abnormal based on the lining wear condition, and displaying a monitoring result.

Monitoring whether the detected loaded condition is abnormal based on the lining wear condition may include determining whether the detected lining wear condition of the brake is abnormal by comparing the lining wear condition with a reference lining wear condition, and determining whether the detected loaded condition is abnormal by comparing the loaded condition with a reference loaded condition corresponding to the abnormal lining wear condition. The displaying the monitoring result may include displaying that the loaded condition is abnormal if the loaded condition is determined as being abnormal.

The method may further include determining the reference loaded condition by comparing the loaded condition detected under the abnormal lining wear condition and the abnormal lining wear condition.

The determining of the reference loaded condition may include determining the reference loaded condition by comparing a lining wear rate pattern at a position of a lining under the lining wear condition and an axial load pattern at a position to which pressure is applied by a load under the loaded condition.

The determining of the reference loaded condition may include determining the reference loaded condition by comparing feature points between the lining wear rate pattern and the axial load pattern.

Displaying that the loaded condition is abnormal if the loaded condition is determined as being abnormal may include displaying that the lining wear condition is abnormal due to the abnormal loaded condition.

The method may further include if the lining wear condition is determined as being abnormal, detecting a tire wear condition of the vehicle after the determination.

The method may further include comparing the tire wear condition detected after the determination with a reference tire wear condition corresponding to the abnormal lining wear condition to determine whether the tire wear condition is abnormal, and if the tire wear condition is determined as being abnormal, displaying that the tire wear condition is abnormal.

The method may further include determining the reference tire wear condition by comparing the tire wear condition detected under the abnormal lining wear condition and the abnormal lining wear condition.

The method may further include displaying the detected tire wear condition.

In addition, displaying the detected tire wear condition may include displaying a remaining available time corresponding to the tire wear condition.

### BRIEF DESCRIPTION OF THE DRAWINGS

The patent or application file contains at least one drawing executed in color. Copies of this patent or patent application publication with color drawings will be provided by the Office upon request and payment of the necessary fee.

These above and/or other aspects of the disclosure will become apparent and more readily appreciated from the following description of exemplary embodiments, taken in conjunction with the accompanying drawings in which:

FIGS. 1A and 1B show the exterior of a vehicle, according to various embodiments of the present disclosure.

FIG. 2 shows the interior of the vehicle in accordance with the embodiment of FIG. 1B.

FIG. 3 is a control block diagram of a vehicle, according to an embodiment of the present disclosure.

FIG. 4 shows how a display displays a tire wear condition, according to an embodiment of the present disclosure.

FIGS. 5A and 5B show how to display a loaded condition on a display, according to various embodiments of the present disclosure.

FIG. 6 shows how a display displays an abnormal tire wear condition, according to an embodiment of the present disclosure.

FIG. 7 shows how a display displays an abnormally loaded condition, according to an embodiment of the present disclosure.

FIG. 8 is a flowchart illustrating a method for controlling a vehicle, according to an embodiment of the present disclosure.

FIG. 9 is a flowchart illustrating a method for controlling a vehicle, according to another embodiment of the present disclosure.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

Reference will now be made in detail to the exemplary embodiments of the present disclosure, examples of which are illustrated in the accompanying drawings, wherein like reference numerals refer to like elements throughout.

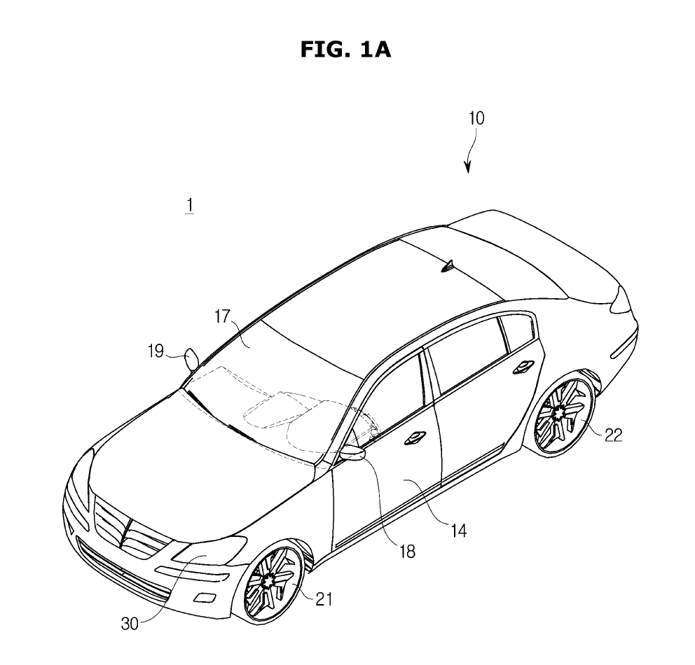

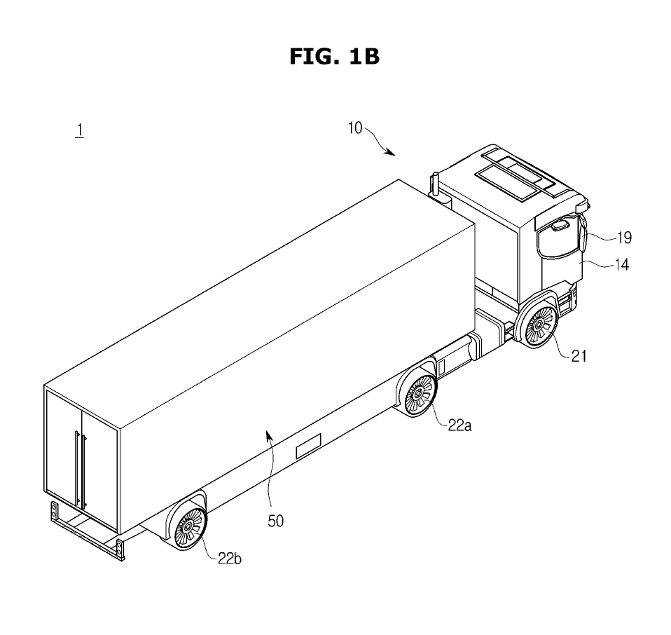

FIGS. 1A and 1B show the exterior of a vehicle, according to various embodiments of the present disclosure.

Referring to FIG. 1A, a vehicle 1 includes a main body 10 forming the exterior of the vehicle 1, wheels 21 and 22 for moving the vehicle 1, doors 14 for shielding the interior of the vehicle 1 from the outside, a front window 17 through which the driver is able to see a view in front of the vehicle 1, and side mirrors 18, 19 for helping the driver see areas behind and to the sides of the vehicle 1.

The wheels 21 and 22 include front wheels 21 equipped on the front side of the vehicle 1 and rear wheels 22 equipped on the rear side of the vehicle 1, and the front wheels 21 or rear wheels 22 may move the main body 10 forward or backward by turning force received from a driving system, which will be described later.

The doors 14 are pivotally attached onto the left and right sides of the main body 10, and opened for the driver to get in and out of the vehicle 1 and closed for shielding the interior of the vehicle 1 from the outside.

The front glass 17, also termed as a windshield glass, is placed on the top front of the main body 10 for the driver in the vehicle 1 to see a view in front of the vehicle 1.

The side mirrors 18 and 19 include a left side mirror 18 and a right side mirror 19 placed on the left and right sides of the main body 10, respectively, for helping the driver obtain views behind and to the sides of the vehicle 1.

Unlike what is shown in FIG. 1A, the vehicle 1 may be implemented as a commercial vehicle used to transport goods or passengers in some embodiments of the present disclosure. The commercial vehicle may include a truck, a dump truck, a van, and a forklift, which are used for transportation of goods, and a bus, a taxi, etc., for transportation of people.

FIG. 1B illustrates the vehicle 1 being implemented in an exemplary manner as a commercial vehicle including a tractor 10, which is a main body, coupled with a trailer 50. The vehicle 1 of FIG. 1B is similar to the vehicle of FIG. 1A except that the non-powered trailer 50 and the tractor 10 having its own power source are connected to move together, and thus a description of the same configuration will be omitted.

The trailer 50 may be loaded with various types of loads. The loads to be loaded on the trailer 50 may include people as well as goods. The trailer 50 connected to the tractor 10 may also be moved along with the tractor 10 by the power source of the tractor 10, enabling transportation of a load loaded in the trailer 50.

The vehicle 1 is shown to have the trailer 50 as a commercial vehicle in FIG. 1B, but it is merely an example of the commercial vehicle.

While FIG. 1B shows an occasion when the rear wheels include a first rear wheel 22a and a second rear wheel 22b, there are no limitations on the number of the rear wheels.

The following description will be made on the assumption that the vehicle 1 is capable of being loaded with a load and the rear wheels include the first rear wheel 22a and the second rear wheel 22b.

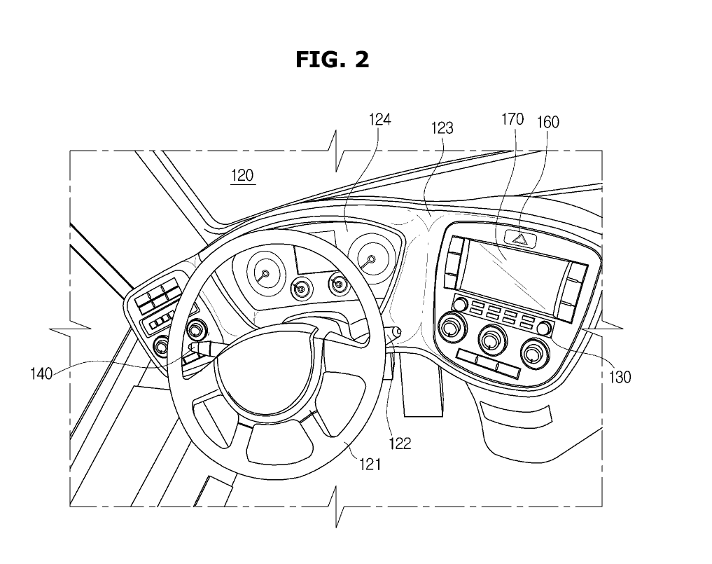

FIG. 2 shows the interior of the vehicle in accordance with the embodiment of FIG. 1B.

The interior of the vehicle 1 may include a driver's seat for the driver and at least one seat for a passenger other than the driver. The driver's seat 120 may be provided with a chair for the driver to sit on and various configurations for operating the vehicle 1. In addition, at least one seat for the passenger may be freely arranged inside the vehicle 1. For example, the seat for the passenger may be arranged by the side of the driver's seat or behind the driver's seat. Alternatively, a plurality of seats for passengers may be arranged in lines on either side of the interior of the vehicle 1 such that an aisle is formed in the middle of the interior of the vehicle 1.

Referring to FIG. 2, the driver's seat may include a dashboard 123, a cluster (i.e., an instrument panel 124) provided on the dashboard 123 for indicating driving functions and vehicle information, such as speed of the vehicle 1, engine revolutions per minute (rpm), fuel amount, coolant conditions, etc., and a steering wheel 121 for manipulating directions of the vehicle 1.

The cluster 124 may be digitally implemented. The digital cluster may display information about the vehicle 1 and driving information in images. The cluster 124 may also display a fuel efficiency of the vehicle 1, which will be described later.

On the steering wheel 121, there may be a turn indication lever to activate one of turn indicator lamps 30 and a retarder lever 122 to activate a brake instruction for the vehicle 1.

The dashboard 123 may have inputs arranged thereon to control interior lighting, air conditioning, Bluetooth systems, opening/closing of the car doors, etc. The dashboard 123 may include a display 170 arranged thereon for displaying navigation information, such as traveling routes to a destination and further include an audio system 130 for outputting sound.

Further, the dashboard 123 may also have an emergency lamp button 160 to receive a command to activate blinking of the entire turn indicator lamps 30.

In the meantime, it is very important for the driver of the vehicle 1 such as a commercial vehicle that generates added-value by transporting a load to maintain and manage the vehicle 1. This is because frequent replacement of parts of the vehicle 1 incurs costs, which in turn reduces its profitability.

The vehicle 1 may thus indicate conditions of various parts to lead to replacement. For example, the vehicle 1 may detect a wear condition of a brake liner in real time, and if replacement of the brake liner is required, inform the driver of this.

However, as described above, providing a current condition of a part is useful only when the part reaches the end of its operational life span and thus needs to be replaced. In other words, the current condition of a part may not be deemed directly relevant to maintenance and use to lead to extension of life span of the part.

Accordingly, the vehicle 1 is required to provide part information to promote a usage pattern for long-term use of the part.

In the following description, it is assumed that the vehicle 1 provides information about loading of a load and/or tire wear condition for extension of the life span of a brake liner among the parts of the vehicle 1.

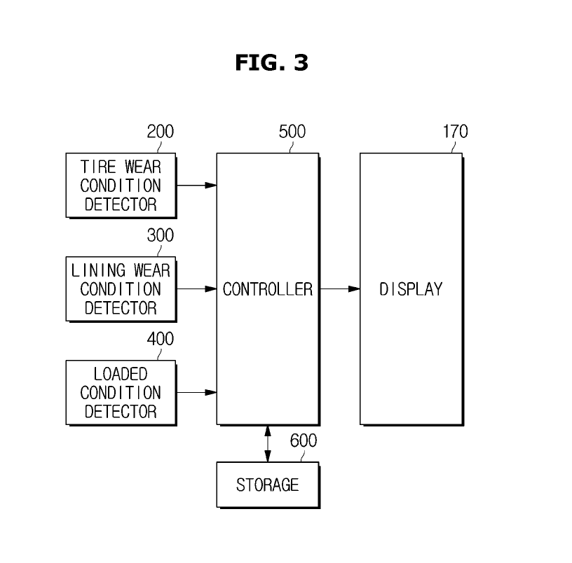

FIG. 3 is a control block diagram of a vehicle, according to an embodiment of the present disclosure.

In the embodiment, the vehicle 1 may include a tire wear condition detector 200 for detecting tire wear conditions of the vehicle 1, a lining wear condition detector 300 for detecting lining wear conditions of the brake, a loaded condition detector 400 for detecting a loaded condition of a load, a display 170 for displaying condition information of a part, a storage for storing information for control, and a controller 500 for controlling the components of the vehicle 1.

The display 170 may display conditions of parts of the vehicle 1 detected by the tire wear condition detector 200, the lining wear condition detector 300, and the loaded condition detector 400 and associated information. The display 170 was described in connection with FIG. 2, so no further explanation for the display 170 will be provided hereinafter.

Although the display 170 is shown as being separate from the instrument panel 124 in FIG. 2, it is possible that the display 170 includes the instrument panel 124.

The tire wear condition detector 200 may detect an extent of wear of a tread pattern formed on the outer surface of the tire. For this, the tire wear condition detector 200 may adopt a Contact Area Information Sensing (CAIS) method. For example, the tire wear condition detector 200 may detect a tire wear condition including depth of the tire tread, one-sided wear, etc., in real time.

The tire wear condition detected in this way may be provided to the driver through the display 170.

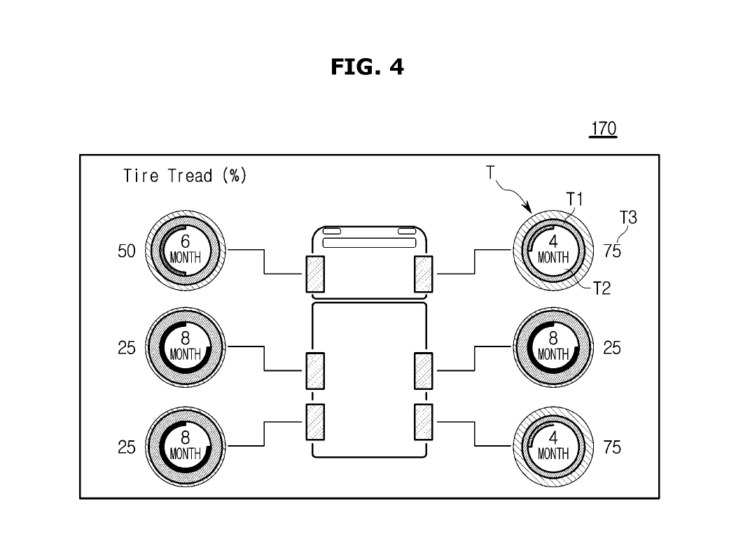

FIG. 4 shows how a display displays a tire wear condition, according to an embodiment of the present disclosure.

Referring to FIG. 4, the display 170 may display a schematic plan view of the vehicle 1 and a plurality of car wheels on the plan view. The display 170 may also display the tire wear condition detected by the tire wear condition detector 200 with the corresponding car wheel.

Specifically, the display 170 may display objects T about the tire wear condition information near the respective car wheels displayed on the display 170. The object T may include a first area T1 having a ringed form corresponding to the thickness of the tire, a second area T2 having a circular form inside the first area T1 for displaying the remaining available time, and a third area T3 outside the first area T1 for representing an extent of tire wear in percentage.

The first area T1 may be formed to have thickness inversely proportional to an extent of tire wear detected by the tire wear condition detector 200. For example, the thickness of the first area T1 of the object T for a tire that is significantly worn out may be thinner than the thickness of the first area T1 of the object T for another tire that is less worn out.

Further, the third area T3 may represent the extent of tire wear detected by the tire wear condition detector 200 in percentage. Therefore, as the number in the third area T3 is nearer to 100, it refers to the extent of tire wear being high. In FIG. 4, the extent of tire wear of the top right tire on the display 170 is seen to be 75%.

Moreover, the remaining available time corresponding to the extent of tire wear detected by the tire wear condition detector 200 may be represented as a number in the second area T2. In FIG. 4, it is seen that the remaining available time of the top right tire on the display 170 is 4 months.

In addition, the second area T2 may also represent the remaining available time even in a ringed chart. Specifically, a ringed chart corresponding to the remaining available time may be represented on the outermost edge of the second area T2. For example, in FIG. 4, if the remaining available time of a tire is one year, the ringed chart may be represented as a full ring, and if the remaining available time of a tire is less than one year, the ringed chart may be represented as an incomplete ring as short as the difference from one year. In another example, in FIG. 4, it is seen that the remaining available time of the top right tire on the display 170 is four months and is represented as an incomplete ringed chart corresponding to the period of time, 4 months.

In this way, the driver may visually check the wear condition of a tire and determine a proper time for replacement.

Referring back to FIG. 3, the loaded condition detector 400 may detect a loaded condition of a load loaded in the vehicle 1. The loaded condition refers to a pressure applied by the load at a position where the loaded condition detector 400 is arranged. For example, in a case as in FIG. 1B where it is possible for the container to be loaded with a load, the loaded condition detector 400 may be located at a plurality of points inside the container for detecting the pressure applied by the load to the points.

In an embodiment, the loaded condition detector 400 may be implemented as tire inflation pressure detection sensors for the front wheels 21 and/or rear wheels 22a, 22b. Once the vehicle 1 is loaded with a load, the weight of the load reaches the tires, and accordingly, the inflation pressure of the tire may increase. The tire inflation pressure detection sensor may detect the pressure applied by the load to the respective tires in proportion to the detected inflation pressure.

In another embodiment, the loaded condition detector 400 may be implemented as an axial load detection sensor. The axial load detection sensor may be equipped in a loading device for typically detecting if a load is evenly loaded in the loading device. For this, the axial load detection sensor may be provided at locations corresponding to the respective car wheels. The axial load detection sensor may detect force applied vertically on the cross-section of the loading device, i.e., an axial load, and may determine the loaded condition in proportion to the detected axial load.

The examples described above are merely examples of the loaded condition detector 400, and are not limited thereto.

The loaded condition detected in this way may be provided to the driver through the display 170.

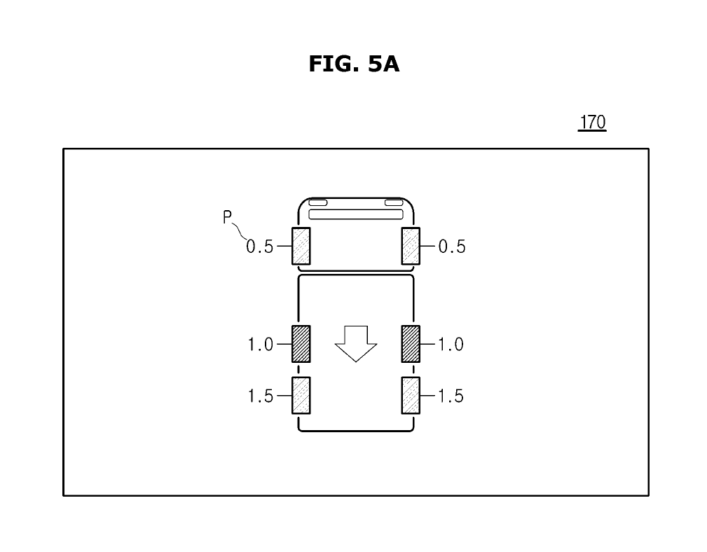

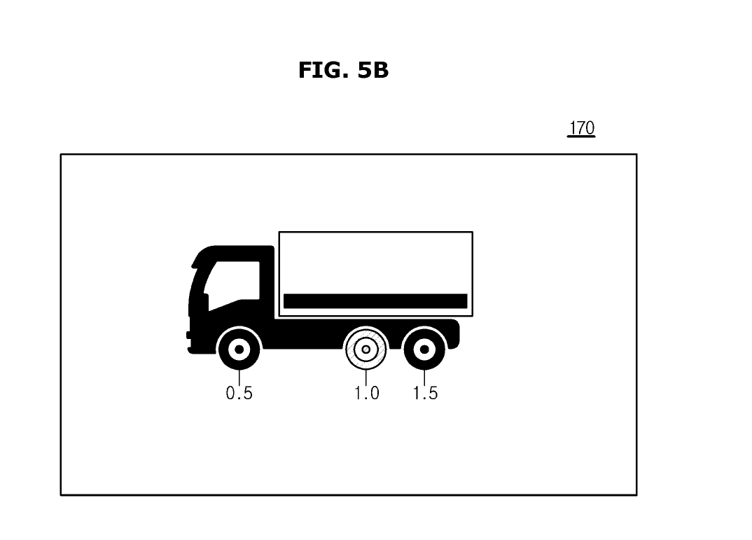

FIGS. 5A and 5B show how to display a loaded condition on a display, according to various embodiments of the present disclosure.

Referring to FIG. 4, the display 170 may display a schematic plan view of the vehicle 1 and a plurality of car wheels on the plan view. The display 170 may also display a loaded condition detected by the loaded condition detector 400, i.e., the magnitude of pressure applied by a load. As described above, with the help of the loaded condition detector 400 detecting pressure applied to the respective car wheels, the display 170 may also display the pressure applied to the displayed car wheels as load information.

Further, the display 170 may display the car wheels with different color, contrast, chroma, brightness, etc., depending on the pressure.

For example, in FIG. 5A, the pressure applied to the first rear wheels 22a is 1.0 and the pressure to the second rear wheels 22b is 1.5. This may mean that the load loaded on the vehicle 1 is not evenly distributed.

How to display the loaded condition information based on the plan view of the vehicle 1 was described in connection with FIG. 5A. Alternatively, the loaded condition information may be displayed on the side view of the vehicle 1.

Referring to FIG. 5B, the display 170 may display a schematic side view of the vehicle 1 and a plurality of car wheels on the side view. The display 170 may also display the pressure applied to the respective car wheels detected by the loaded condition detector 400.

In this way, the driver may easily check the loaded condition of a load with his/her eyes.

Turning back to FIG. 3, the lining wear condition detector 300 may detect a lining wear condition of the brake in real time. For this, the lining wear condition detector 300 may be implemented as a Lining Wear Sensor (LWS). The LWS may detect a gap between a brake drum and the lining as a lining wear condition.

The lining wear condition detector 300 may represent the lining wear condition as a percentage of an extent of the lining wear. Further, the display 170 may provide the lining wear condition to the driver by displaying the percentage of the extent of the lining wear detected by the lining wear condition detector 300. This will be described in more detail later.

Moreover, the lining wear condition detector 300 may detect a lining wear rate as the lining wear condition. Specifically, the lining wear condition detector 300 may detect the lining wear rate by measuring a change in the extent of lining wear for a predetermined period of time.

In a normal condition, the lining wear rates for the respective car wheels may appear to be constant or similar to each other. If the lining wear rate of some car wheels is excessively faster than that of the other car wheels, the lining wear condition may be said to be abnormal. Like this, some lining wear conditions being abnormal require a check because they may be affected by the loaded condition and/or the tire wear condition.

Accordingly, the controller 500 may be able to monitor the loaded condition and/or tire wear condition based on the lining wear condition. For example, the controller 500 may determine lining wear patterns based on the accumulated lining wear conditions and monitor whether the lining wear patterns, the loaded condition, and/or the tire wear condition is abnormal by comparing the determined lining wear patterns and the loaded condition and/or the tire wear condition. If the loaded condition and/or the tire wear condition has a similar tendency to the lining wear patterns, the controller 500 may determine the loaded condition and/or the tire wear condition as being abnormal.

Alternatively, the controller 500 may first determine whether the lining wear condition is abnormal, and then determine the loaded condition and/or the tire wear condition under the abnormal lining wear condition.

First, the controller 500 may determine a reference lining wear condition to determine whether the lining wear condition is abnormal. The reference lining wear condition may be a threshold for the normal lining wear condition.

The reference lining wear condition may be determined by an external input or computation of the controller 500. For example, the controller 500 may determine the reference lining wear condition to be an average of lining wear rates for the respective car wheels detected by the lining wear condition detector 300. Alternatively, the controller 500 may determine the reference lining wear condition based on the average.

Once the reference lining wear condition is determined, the controller 500 may compare the respective lining wear conditions with the reference lining wear condition. From the comparison, the controller 500 may determine a lining that has worn more severely than the reference lining wear condition to be abnormal.

Once the lining wear condition is determined to be abnormal, the controller 500 may then determine a reference loaded condition and/or a reference tire wear condition corresponding to the determined lining wear condition. The reference loaded condition may refer to a reference value to determine an abnormal loaded condition under the abnormal lining wear condition, and the reference tire wear condition may refer to a reference value to determine an abnormal tire wear condition under the abnormal lining wear condition.

To determine the reference tire wear condition, the controller 500 may compare a tire wear condition detected by the tire wear condition detector 200 under the abnormal lining wear condition with the abnormal lining wear condition. Specifically, the controller 500 may compare a lining wear rate pattern at a position of the lining in a lining wear condition and a tire wear pattern corresponding to the car wheel.

For example, the lining wear rate pattern may refer to a wear rate chart of the lining corresponding to the car wheel, and the tire wear pattern may refer to a chart of the extent of tire wear corresponding to the car wheel. The controller 500 may extract feature points from the lining wear rate pattern and the tire wear pattern, and then determine that the tire wear condition is abnormal if there are feature points corresponding to the same car wheel. This is based on the assumption that the abnormal lining wear condition has been caused by an abnormal tire wear condition.

Once the tire condition is determined to be abnormal, the controller 500 may determine this tire wear condition as the reference tire wear condition. The reference tire wear condition determined this way may be stored in the storage 600 and provided to the controller 500 if needed.

Once the reference tire wear condition is determined according to the above process, the controller 500 may compare a tire wear condition detected by the tire wear condition detector 200 in real time and the reference tire wear condition, and based on the comparison, may determine whether the current tire wear condition is abnormal. Further, since the lining wear condition may be abnormal if the current tire wear condition is abnormal, the controller 500 may control the display 170 to display that the tire wear condition is abnormal.

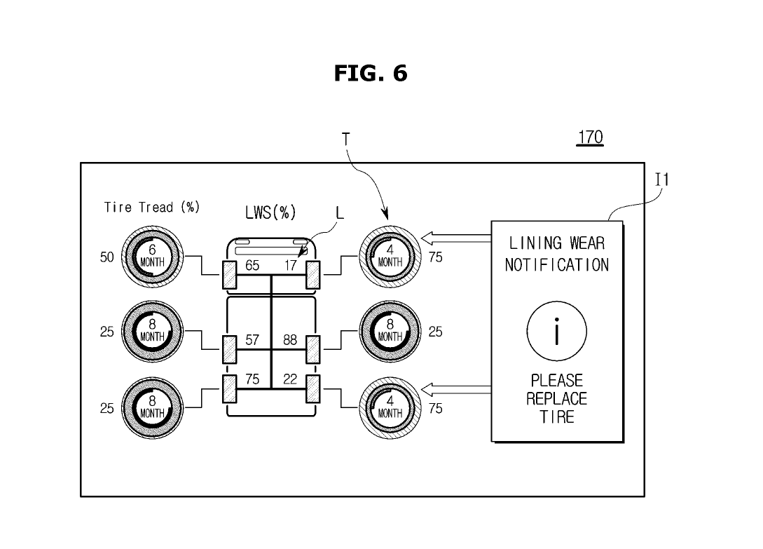

FIG. 6 shows how a display displays an abnormal tire wear condition, according to an embodiment of the present disclosure. FIG. 6 illustrates an occasion when the respective lining wear conditions L are displayed in the case of FIG. 4.

FIG. 6 shows an example where the controller 500 determines the detected currently tire wear condition is abnormal because the current tire wear condition is greater than the reference tire wear condition. In a case that the reference tire wear condition is 70%, which is a percentage of an extent of tire wear, since the percentages of the extent of tire wear of the tires corresponding to the top right and bottom right car wheels are 75% which is greater than the reference tire wear condition 70%, the controller 500 may control the display 170 to display that the tire wear conditions of the top right and bottom right tires are abnormal. Further, the controller 500 may control the display 170 to display an object to lead to replacement of the tire in an abnormal wear condition.

In FIG. 6, the display 170 may display object I1 to lead to replacement of a tire in the abnormal wear condition. The object I1 may also display a warning that the tire in the abnormal wear condition would lead to an abnormal lining wear condition.

By replacing the abnormally worn tire in an early stage, the driver may prevent lining wear from the abnormally worn tire. As a result, it may delay the replacement of the

Further, to determine the reference loaded condition, the controller 500 may compare a loaded condition detected by the loaded condition detector 400 under the abnormal lining wear condition with the abnormal lining wear condition. Specifically, the controller 500 may compare a lining wear rate pattern at a position of the lining under a lining wear condition and an axial load pattern at a position to which pressure is applied by a load under a loaded condition.

For example, the lining wear rate pattern may refer to the wear rate chart of the lining corresponding to the car wheel, and the axial load pattern may refer to a chart of the axial load corresponding to the car wheel. The controller 500 may extract feature points from the lining wear rate pattern and the axial load pattern, and then determine that the loaded condition is abnormal if there are feature points corresponding to the same car wheel. This is based on the assumption that the abnormal lining wear condition has been caused by an abnormally loaded condition.

If the loaded condition is abnormal, the controller 500 may determine this loaded condition as the reference loaded condition. The reference loaded condition determined this way may be stored in the storage 600 and provided to the controller 500 if needed.

Once the reference loaded condition is determined according to the above process, the controller 500 may compare a loaded condition detected by the loaded condition detector 400 in real time and the reference loaded condition, and based on the comparison, may determine whether the current loaded condition is abnormal. Further, since the lining wear condition may also be abnormal if the current loaded condition is abnormal, the controller 500 may control the display 170 to display that the loaded condition is abnormal.

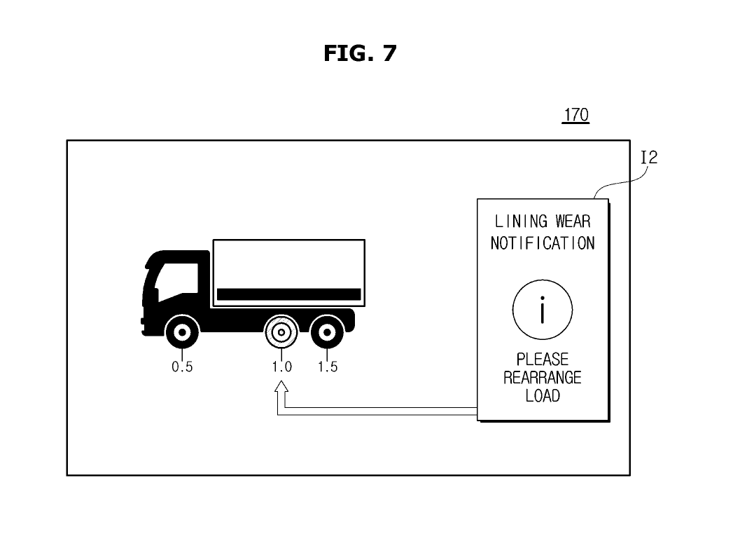

FIG. 7 shows how a display displays an abnormally loaded condition, according to an embodiment of the present disclosure.

FIG. 7 shows an example where the controller 500 determines that the detected current loaded condition is abnormal because the current loaded condition is greater than the reference loaded condition. In a case that the reference loaded condition is 1.0, which is the magnitude of the axial load, since the axial load applied to the first car wheels 22a is equal to the reference axial load 1.0, the controller 500 may control the display 170 to display that a loaded condition at a position corresponding to the first car wheel 22a is abnormal. Further, the controller 500 may control the display 170 to display an object to lead to rearrangement of the load that causes the abnormally loaded condition.

In FIG. 7, the display 170 may display object 12 to lead to rearrangement of the load that causes the abnormally loaded condition. The object 12 may also display a warning that the abnormally loaded load would lead to an abnormal lining wear condition.

Through this, by rearranging the abnormally loaded load, the driver may prevent lining wear from the abnormally loaded load. As a result, it may delay the replacement of the lining.

The case where the vehicle 1 separately determines whether the loaded condition and the tire wear condition are abnormal and displays the result of determination was described. However, it is also possible for the vehicle 1 to first determine whether a loaded condition is abnormal and then determine whether the tire wear condition is abnormal if the loaded condition is normal, and vice versa.

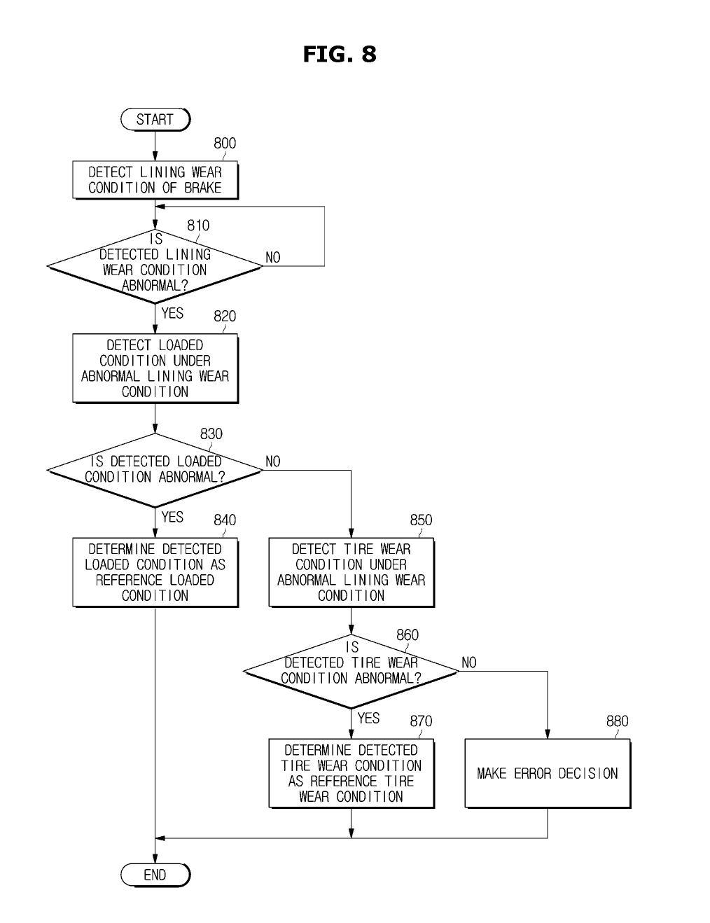

FIG. 8 is a flowchart illustrating a method for controlling a vehicle, according to an embodiment of the present disclosure. Specifically, FIG. 8 shows a procedure of determining the reference loaded condition and/or the reference tire wear condition.

First, the vehicle 1 detects a wear condition of the brake lining, in 800. Next, the vehicle 1 determines whether the detected lining wear condition is abnormal, in 810. Specifically, the vehicle 1 may determine whether the detected lining wear condition is abnormal by comparing it with the reference lining wear condition. The reference lining wear condition may be determined by an external input or internal computation of the vehicle 1.

If the detected lining wear condition is normal, this may be repeatedly determined.

On the other hand, if the detected lining wear condition is abnormal, the vehicle 1 detects a loaded condition under the abnormal lining wear condition, in 820. The detected loaded condition may refer to the pressure applied to a position corresponding to each car wheel.

Next, the vehicle 1 determines whether the detected loaded condition is abnormal, in 830. Specifically, the vehicle 1 may determine whether the loaded condition is abnormal by comparing an axial load pattern under the detected loaded condition and a lining wear rate pattern under an abnormal lining wear condition.

If the loaded condition is determined as being abnormal, the vehicle 1 determines the detected loaded condition as the reference loaded condition, 840. This may be used to determine whether the future loaded condition is abnormal.

On the other hand, if the loaded condition is determined to be normal, the vehicle 1 detects a tire wear condition under an abnormal lining wear condition, in 850. The detected tire wear condition may refer to an extent of tire wear corresponding to each car wheel.

Next, the vehicle 1 determines whether the detected tire wear condition is abnormal, in 860. Specifically, the vehicle 1 may determine whether the tire wear condition is abnormal by comparing a tire wear pattern under the detected tire wear condition and the lining wear rate pattern under the abnormal lining wear condition.

If the tire wear condition is determined as being abnormal, the vehicle 1 determines the detected tire wear condition as the reference tire wear condition, 870. This may be used to determine whether the future tire wear condition is abnormal.

On the other hand, if the tire wear condition is determined to be normal, it is difficult to find a cause of the abnormal lining wear condition and thus the vehicle 1 makes an error decision in 880 and stops the procedure.

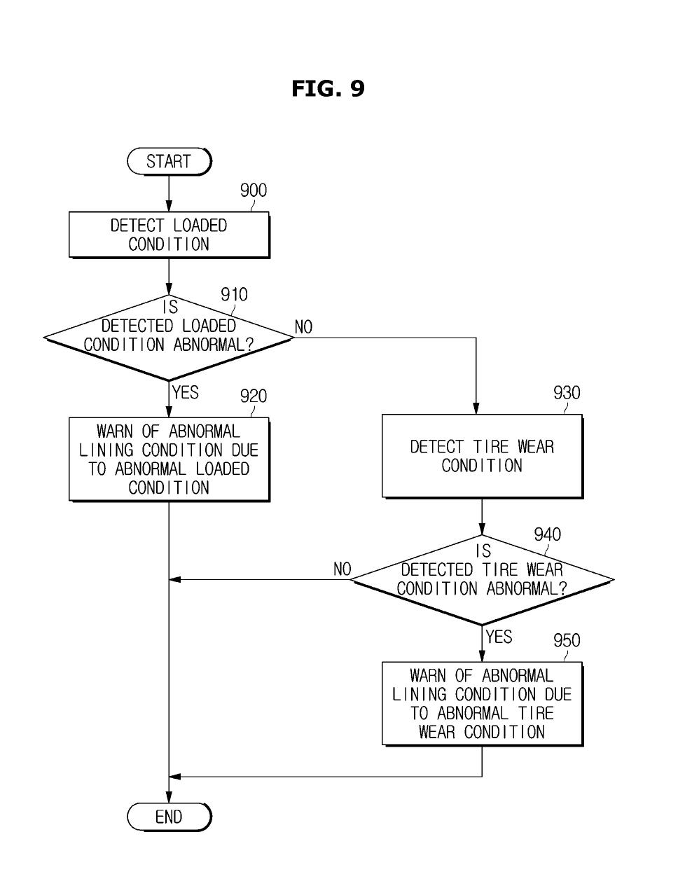

FIG. 9 is a flowchart illustrating a method for controlling a vehicle, according to another embodiment of the present disclosure. Specifically, FIG. 9 illustrates a procedure of determining whether the current loaded condition and/or the current tire wear condition is abnormal based on the reference loaded condition and/or the reference tire wear condition.

First, the vehicle 1 detects a loaded condition, in 900. The detected loaded condition may refer to the pressure applied to a position corresponding to each car wheel.

Next, the vehicle 1 determines whether the detected loaded condition is abnormal, in 910. Specifically, the vehicle 1 may compare the detected loaded condition and the reference loaded condition determined in FIG. 8, to determine whether the loaded condition is abnormal.

If the loaded condition is determined as being abnormal, the vehicle 1 displays a warning that the lining wear condition is abnormal due to the abnormal loaded condition, in 920.

On the other hand, if the loaded condition is determined to be normal, the vehicle 1 detects a tire wear condition, in 930. The detected tire wear condition may refer to an extent of tire wear corresponding to each car wheel.

Next, the vehicle 1 determines whether the detected tire wear condition is abnormal, in 940. Specifically, the vehicle 1 may determine whether the detected tire wear condition is abnormal by comparing it with the reference tire wear condition determined in FIG. 8.

If the tire wear condition is determined as being abnormal, the vehicle 1 displays a warning that the lining wear condition is abnormal due to the abnormal tire wear condition, in 950.

On the other hand, if the tire wear condition is determined to be normal, the vehicle 1 determines that the lining wear condition is normal and stops the procedure.

Exemplary embodiments of the present disclosure have been described above. In the exemplary embodiments described above, some components may be implemented as a “module”. As provided herein, the term “module” encompasses, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, for example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

In addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A vehicle, comprising:
a lining wear condition detector configured to detect a lining wear condition of a brake;
a load detector configured to detect a loaded condition;
a controller configured to monitor whether the detected loaded condition is abnormal based on the lining wear condition; and
a display configured to display a monitoring result.

2. The vehicle of claim 1, wherein the controller is configured to, if the detected lining wear condition is determined as being abnormal by comparison between the lining wear condition and a reference lining wear condition, compare the loaded condition detected after the determination with a reference loaded condition corresponding to the abnormal lining wear condition and control the display to display that the loaded condition is abnormal.

3. The vehicle of claim 2, wherein the controller is configured to determine the reference loaded condition by comparing the loaded condition detected under the abnormal lining wear condition and the abnormal lining wear condition.

4. The vehicle of claim 3, wherein the controller is configured to determine the reference loaded condition by comparing a lining wear rate pattern at a position of a lining under the lining wear condition and an axial load pattern at a position to which pressure is applied by a load under the loaded condition.

5. The vehicle of claim 4, wherein the controller is configured to determine the reference loaded condition by comparing feature points between the lining wear rate pattern and the axial load pattern.

6. The vehicle of claim 2, wherein the controller is configured to control the display to display that the lining wear condition is abnormal due to the abnormal loaded condition.

7. The vehicle of claim 2, further comprising: a tire wear condition detector configured to detect a tire wear condition of the vehicle.

8. The vehicle of claim 7, wherein the controller is configured to, if the lining wear condition is determined as being abnormal, compare the tire wear condition detected after the determination with a reference tire wear condition corresponding to the abnormal lining wear condition and control the display to display that the tire wear condition is abnormal.

9. The vehicle of claim 8, wherein the controller is configured to determine the reference tire wear condition by comparing the tire wear condition detected under the abnormal lining wear condition and the abnormal lining wear condition.

10. The vehicle of claim 7, wherein the controller is configured to control the display to display the detected tire wear condition.

11. The vehicle of claim 10, wherein the controller is configured to control the display to display a remaining available time corresponding to the tire wear condition.

12. A method for controlling a vehicle, the method comprising:
detecting a lining wear condition of a brake;
detecting a loaded condition;
monitoring whether the detected loaded condition is abnormal based on the lining wear condition; and
displaying a monitoring result.

13. The method of claim 12, wherein monitoring whether the detected loaded condition is abnormal based on the lining wear condition comprises:
determining whether the detected lining wear condition of the brake is abnormal by comparing the lining wear condition with a reference lining wear condition; and
determining whether the detected loaded condition is abnormal by comparing the loaded condition with a reference loaded condition corresponding to the abnormal lining wear condition,
wherein displaying the monitoring result comprises:
displaying that the loaded condition is abnormal if the loaded condition is determined as being abnormal.

14. The method of claim 13, further comprising: determining the reference loaded condition by comparing the loaded condition detected under the abnormal lining wear condition and the abnormal lining wear condition.

15. The method of claim 14, wherein the determining of the reference loaded condition comprises:
determining the reference loaded condition by comparing a lining wear rate pattern at a position of a lining under the lining wear condition and an axial load pattern at a position to which pressure is applied by a load under the loaded condition.

16. The method of claim 15, wherein the determining of the reference loaded condition comprises:
determining the reference loaded condition by comparing feature points between the lining wear rate pattern and the axial load pattern.

17. The method of claim 13, wherein displaying that the loaded condition is abnormal if the loaded condition is determined as being abnormal comprises:
displaying that the lining wear condition is abnormal due to the abnormal loaded condition.

18. The method of claim 13, further comprising: if the lining wear condition is determined as being abnormal, detecting a tire wear condition of the vehicle after the determination.

19. The method of claim 18, further comprising:
comparing the tire wear condition detected after the determination with a reference tire wear condition corresponding to the abnormal lining wear condition to determine whether the tire wear condition is abnormal; and
if the tire wear condition is determined as being abnormal, displaying that the tire wear condition is abnormal.

20. The method of claim 19, further comprising: determining the reference tire wear condition by comparing the tire wear condition detected under the abnormal lining wear condition and the abnormal lining wear condition.

21. The method of claim 18, further comprising: displaying the detected tire wear condition.

22. The method of claim 21, wherein displaying the detected tire wear condition comprises
displaying a remaining available time corresponding to the tire wear condition.
